(19) United States
(12) Patent Application Publication
(10) Pub. No.: US 2023/0337318 A1
(43) Pub. Date: Oct. 19, 2023

(54) METHOD AND DEVICE FOR PERFORMING COMMUNICATION ON BASIS OF SL DRX IN NR V2X

(71) Applicant: LG ELECTRONICS INC., Seoul (KR)

(72) Inventors: Woosuk KO, Seoul (KR); Hanbyul SEO, Seoul (KR)

(73) Assignee: LG ELECTRONICS INC., Seoul (KR)

(21) Appl. No.: 18/044,327

(22) PCT Filed: Sep. 16, 2021
(86) PCT No.: PCT/KR2021/012674

§ 371 Date: Mar. 7, 2023

(30) Foreign Application Priority Data
Sep. 16, 2020 (KR) 10-2020-0118963
Sep. 17, 2020 (KR) 10-2020-0119792
Sep. 25, 2020 (KR) 10-2020-0124993

(51) Int. Cl. H04W 76/28; H04W 72/25; H04W 72/1263

(52) U.S. Cl. CPC H04W 76/28; H04W 72/25; H04W 72/1263

(57) ABSTRACT

A method for performing wireless communication by a first device and an apparatus supporting same are provided. The method may comprise the steps of: selecting a sidelink (SL) discontinuous reception (DRX) configuration for groupcast communication among at least one SL DRX configuration, the SL DRX configuration including information related to a DRX cycle and information related to an active time; transmitting first sidelink control information (SCI) for scheduling a physical sidelink shared channel (PSSCH) to at least one second device in a group through a physical sidelink control channel (PSCCH); transmitting second SCI including a destination ID and information related to the SL DRX configuration to the at least one second device through the PSSCH; and on the basis of the SL DRX configuration, performing the groupcast communication with the at least one second device.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic. Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

Thereafter, regarding V2X communication, various V2X scenarios are proposed in NR. For example, the various V2X scenarios may include vehicle platooning, advanced driving, extended sensors, remote driving, or the like.

### SUMMARY

Meanwhile, if discontinuous reception (DRX) cycle configurations are different between UEs in a group in which groupcast communication is performed, a UE B may not receive data transmitted by a UE A during an active time period of the UE B. Accordingly, the DRX cycle need to be aligned between UEs in a group in which groupcast communication is performed.

In one embodiment, provided is a method for performing wireless communication by a first device. The method may comprise: selecting a sidelink (SL) discontinuous reception (DRX) configuration for groupcast communication from among at least one SL DRX configuration, wherein the SL DRX configuration includes information related to a DRX cycle and information related to an active time; transmitting, to at least one second device within a group, first sidelink control information (SCI) for scheduling a physical sidelink shared channel (PSSCH) through a physical sidelink control channel (PSCCH); transmitting, to the at least one second device, second SCI including information related to the SL DRX configuration and a destination ID through the PSSCH; and performing, based on the SL DRX configuration, the groupcast communication with the at least one second device.

In one embodiment, provided is a first device adapted to perform wireless communication. The first device may comprise: one or more memories storing instructions; one or more transceivers; and one or more processors connected to the one or more memories and the one or more transceivers. For example, the one or more processors may execute the instructions to: select a sidelink (SL) discontinuous reception (DRX) configuration for groupcast communication from among at least one SL DRX configuration, wherein the SL DRX configuration includes information related to a DRX cycle and information related to an active time; transmit, to at least one second device within a group, first sidelink control information (SCI) for scheduling a physical sidelink shared channel (PSSCH) through a physical sidelink control channel (PSCCH); transmit, to the at least one second device, second SCI including information related to the SL DRX configuration and a destination ID through the PSSCH; and perform, based on the SL DRX configuration, the groupcast communication with the at least one second device.

Power consumption of the UE can be saved.

### BRIEF DESCRIPTION OF THE DRAWINGS

FIG. 1 is a drawing for describing V2X communication based on NR, compared to V2X communication based on RAT used before NR.

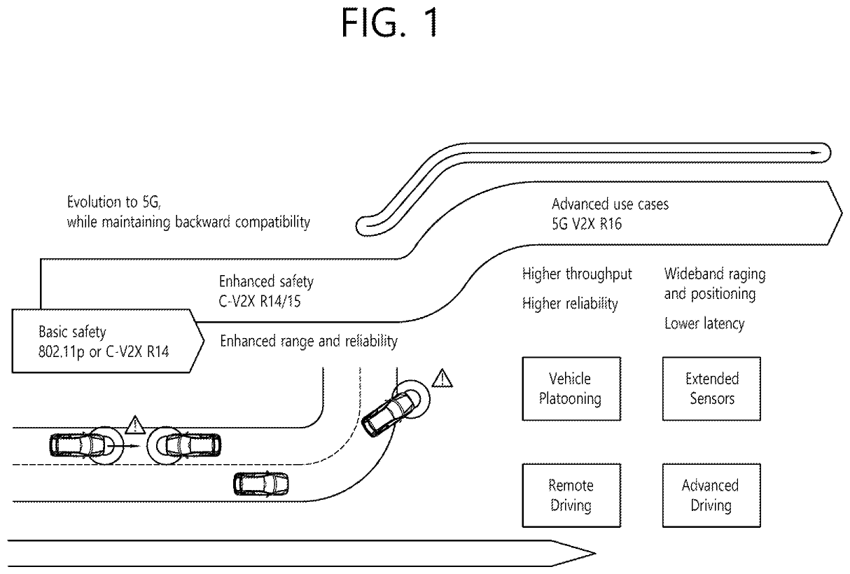

FIG. 2 shows a structure of an NR system, based on an embodiment of the present disclosure.

FIG. 3 shows a radio protocol architecture, based on an embodiment of the present disclosure.

FIG. 4 shows a structure of a radio frame of an NR, based on an embodiment of the present disclosure.

FIG. 5 shows a structure of a slot of an NR frame, based on an embodiment of the present disclosure.

FIG. 6 shows an example of a BWP, based on an embodiment of the present disclosure.

FIG. 7 shows a UE performing V2X or SL communication, based on an embodiment of the present disclosure.

FIG. 8 shows a procedure of performing V2X or SL communication by a UE based on a transmission mode, based on an embodiment of the present disclosure.

FIG. 9 shows three cast types, based on an embodiment of the present disclosure.

FIG. 10 shows an example of a DRX cycle, based on an embodiment of the present disclosure.

FIG. 11 shows a procedure for a UE to perform groupcast communication based on a DRX cycle configuration, based on an embodiment of the present disclosure.

FIG. 12 shows a procedure for a UE to perform groupcast communication based on a DRX cycle configuration, based on an embodiment of the present disclosure.

FIG. 13 shows a method for a UE to perform aggregation for DRX cycles, based on an embodiment of the present disclosure.

FIG. 14 shows an example of aggregation for DRX cycles, based on an embodiment of the present disclosure.

FIG. 15 shows a procedure for a UE to perform SL communication based on a DRX resource pool, based on an embodiment of the present disclosure.

FIG. 16 shows a method for performing wireless communication by a first device, based on an embodiment of the present disclosure.

FIG. 17 shows a method for performing wireless communication by a second device, based on an embodiment of the present disclosure.

FIG. 18 shows a communication system 1, based on an embodiment of the present disclosure.

FIG. 19 shows wireless devices, based on an embodiment of the present disclosure.

FIG. 20 shows a signal process circuit for a transmission signal, based on an embodiment of the present disclosure.

FIG. 21 shows another example of a wireless device, based on an embodiment of the present disclosure.

FIG. 22 shows a hand-held device, based on an embodiment of the present disclosure.

FIG. 23 shows a vehicle or an autonomous vehicle, based on an embodiment of the present disclosure.

### DETAILED DESCRIPTION

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”. [37] In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

A technical feature described individually in one figure in the present specification may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

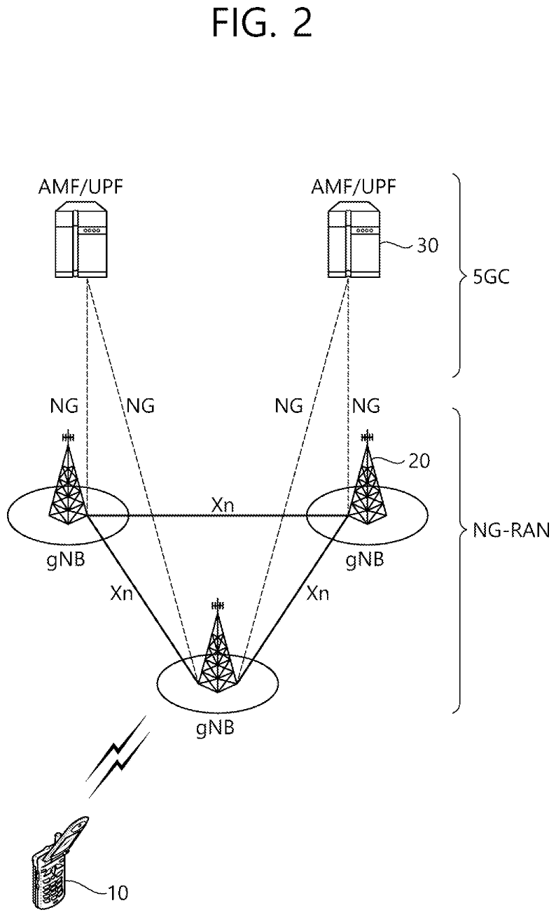

FIG. 2 shows a structure of an NR system, based on an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

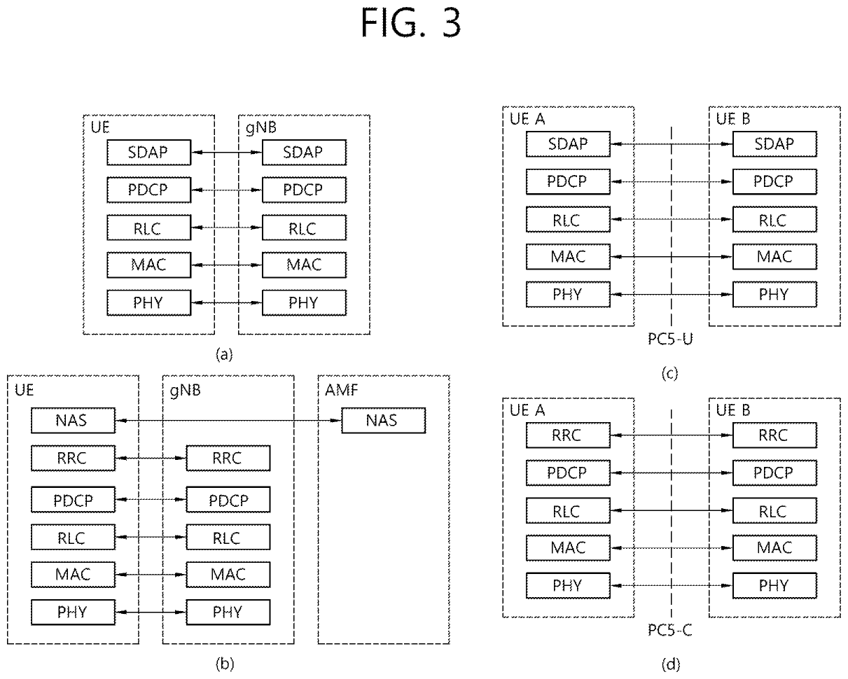

FIG. 3 shows a radio protocol architecture, based on an embodiment of the present disclosure. The embodiment of FIG. 3 may be combined with various embodiments of the present disclosure. Specifically, (a) of FIG. 3 shows a radio protocol stack of a user plane for Uu communication, and (b) of FIG. 3 shows a radio protocol stack of a control plane for Uu communication. (c) of FIG. 3 shows a radio protocol stack of a user plane for SL communication, and (d) of FIG. 3 shows a radio protocol stack of a control plane for SL communication.

Referring to FIG. 3, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, a packet data convergence protocol (PDCP) layer, and a service data adaptation protocol (SDAP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC CONNECTED state, and, otherwise, the UE may be in an RRC IDLE state. In case of the NR, an RRC INACTIVE state is additionally defined, and a UE being in the RRC INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

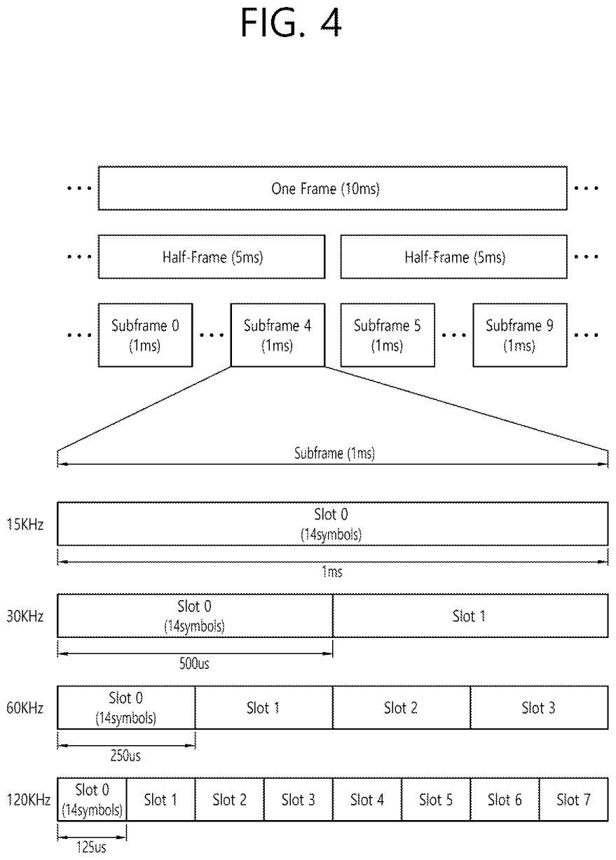

FIG. 4 shows a structure of a radio frame of an NR, based on an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP is used.

TABLE 1

| | | | |
|---|---|---|---|
| SCS (15*2^{u}) | N^{slot}_{symb} | N^{frame, u}ₛₗₒₜ | N^{subframe, u}ₛₗₒₜ |

| | | | | |
|---|---|---|---|---|
| 15 | KHz (u = 0) | 14 | 10 | 1 |
| 30 | KHz (u = 1) | 14 | 20 | 2 |
| 60 | KHz (u = 2) | 14 | 40 | 4 |
| 120 | KHz (u = 3) | 14 | 80 | 8 |
| 240 | KHz (u = 4) | 14 | 160 | 16 |

Table 2 shows an example of a number of symbols per slot, a number of slots per frame, and a number of slots per subframe based on the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

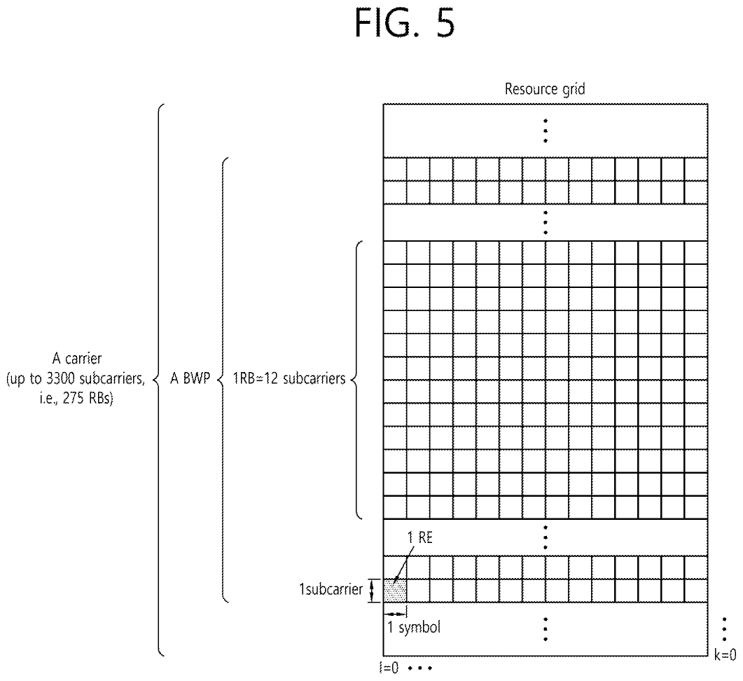

FIG. 5 shows a structure of a slot of an NR frame, based on an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRB s) for the given numerology on a given carrier

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information-reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. For example, the UE may receive a configuration for the Uu BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

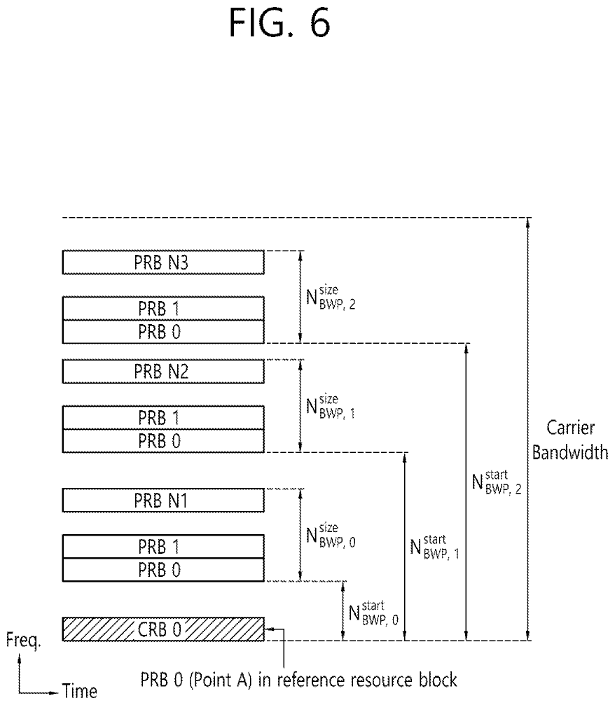

FIG. 6 shows an example of a BWP, based on an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

A sidelink synchronization signal (SLSS) may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

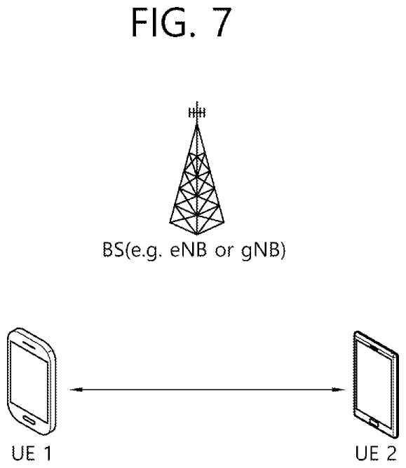

FIG. 7 shows a UE performing V2X or SL communication, based on an embodiment of the present disclosure. The embodiment of FIG. 7 may be combined with various embodiments of the present disclosure.

Referring to FIG. 7, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

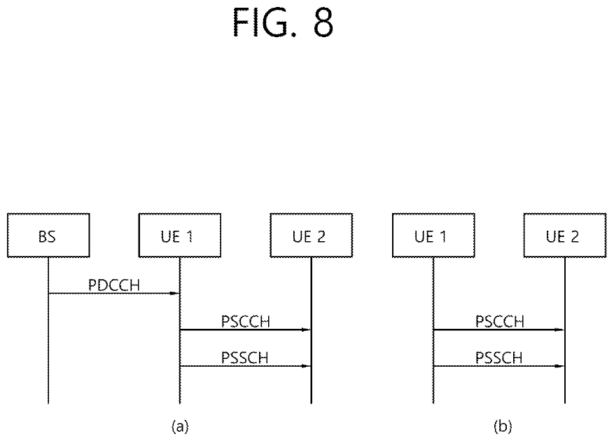

FIG. 8 shows a procedure of performing V2X or SL communication by a UE based on a transmission mode, based on an embodiment of the present disclosure. The embodiment of FIG. 8 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, (a) of FIG. 8 shows a UE operation related to an LTE transmission mode 1 or an LTE transmission mode 3. Alternatively, for example, (a) of FIG. 8 shows a UE operation related to an NR resource allocation mode 1. For example, the LTE transmission mode 1 may be applied to general SL communication, and the LTE transmission mode 3 may be applied to V2X communication.

For example, (b) of FIG. 8 shows a UE operation related to an LTE transmission mode 2 or an LTE transmission mode 4. Alternatively, for example, (b) of FIG. 8 shows a UE operation related to an NR resource allocation mode 2.

Referring to (a) of FIG. 8, in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (e.g., downlink control information (DCI)) or RRC signaling (e.g., Configured Grant Type 1 or Configured Grant Type 2), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to (b) of FIG. 8, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

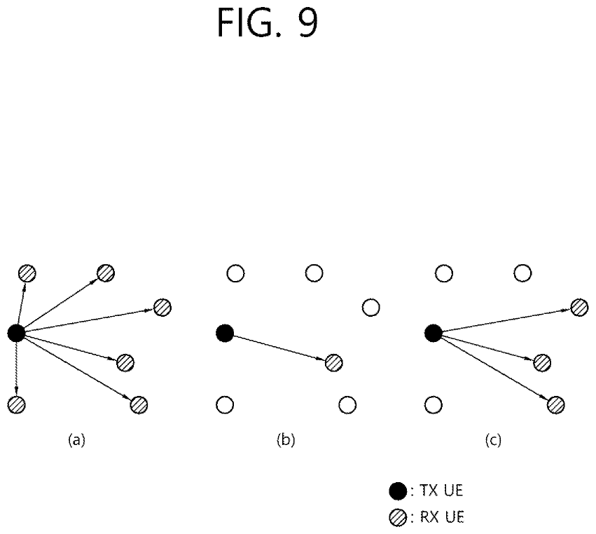

FIG. 9 shows three cast types, based on an embodiment of the present disclosure. The embodiment of FIG. 9 may be combined with various embodiments of the present disclosure. Specifically, (a) of FIG. 9 shows broadcast-type SL communication, (b) of FIG. 9 shows unicast type-SL communication, and (c) of FIG. 9 shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hereinafter, a sidelink control information (SCI) will be described.

Control information transmitted by a BS to a UE through a PDCCH may be referred to as downlink control information (DCI), whereas control information transmitted by the UE to another UE through a PSCCH may be referred to as SCI. For example, the UE may know in advance a start symbol of the PSCCH and/or the number of symbols of the PSCCH, before decoding the PSCCH. For example, the SCI may include SL scheduling information. For example, the UE may transmit at least one SCI to another UE to schedule the PSSCH. For example, one or more SCI formats may be defined.

For example, a transmitting UE may transmit the SCI to a receiving UE on the PSCCH. The receiving UE may decode one SCI to receive the PSSCH from the transmitting UE.

For example, the transmitting UE may transmit two consecutive SCIs (e.g., 2-stage SCI) to the receiving UE on the PSCCH and/or the PSSCH. The receiving UE may decode the two consecutive SCIs (e.g., 2-stage SCI) to receive the PSSCH from the transmitting UE. For example, if SCI configuration fields are divided into two groups in consideration of a (relatively) high SCI payload size, an SCI including a first SCI configuration field group may be referred to as a first SCI or a 1^{st} SCI, and an SCI including a second SCI configuration field group may be referred to as a second SCI or a 2^{nd} SCI. For example, the transmitting UE may transmit the first SCI to the receiving UE through the PSCCH. For example, the transmitting UE may transmit the second SCI to the receiving UE on the PSCCH and/or the PSSCH. For example, the second SCI may be transmitted to the receiving UE through an (independent) PSCCH, or may be transmitted in a piggyback manner together with data through the PSSCH. For example, two consecutive SCIs may also be applied to different transmissions (e.g., unicast, broadcast, or groupcast).

For example, the transmitting UE may transmit the entirety or part of information described below to the receiving UE through the SCI. Herein, for example, the transmitting UE may transmit the entirety or part of the information described below to the receiving UE through the first SCI and/or the second SCI.
PSSCH and/or PSCCH related resource allocation information, e.g., the number/positions of time/frequency resources, resource reservation information (e.g., period), and/or
SL CSI report request indicator or SL (L1) RSRP (and/or SL (L1) RSRQ and/or SL (L1) RSSI) report request indicator, and/or
SL CSI transmission indicator (or SL (L1) RSRP (and/or SL (L1) RSRQ and/or SL (L1) RSSI) information transmission indicator)) (on PSSCH), and/or
MCS information, and/or
Transmit power information, and/or
L1 destination ID information and/or L1 source ID information, and/or
SL HARQ process ID information, and/or
New data indicator (NDI) information, and/or
Redundancy version (RV) information, and/or
(Transmission traffic/packet related) QoS information, e.g., priority information, and/or
SL CSI-RS transmission indicator or information on the number of (to-be-transmitted) SL CSI-RS antenna ports, and/or
Location information of a transmitting UE or location (or distance region) information of a target receiving UE (for which SL HARQ feedback is requested), and/or
Reference signal (e.g., DMRS, etc.) related to channel estimation and/or decoding of data to be transmitted through a PSSCH, e.g., information related to a pattern of a (time-frequency) mapping resource of DMRS, rank information, antenna port index information

For example, the first SCI may include information related to channel sensing. For example, the receiving UE may decode the second SCI by using a PSSCH DMRS. A polar code used in a PDCCH may be applied to the second SCI. For example, in a resource pool, a payload size of the first SCI may be identical for unicast, groupcast, and broadcast. After decoding the first SCI, the receiving UE does not have to perform blind decoding of the second SCI. For example, the first SCI may include scheduling information of the second SCI.

Hereinafter, power saving will be described.

For the power saving method of the UE, UE adaptation for traffic and power consumption characteristics, adaptation according to change in frequency/time, adaption to the antenna(s), adaptation to discontinuous reception (DRX) configurations, adaptation to UE processing capability, adaptation for reduction of PDCCH monitoring/decoding, power saving signal/channel/procedure for triggering adaptation for UE power consumption, power consumption reduction during RRM measurement, etc. may be considered.

Hereinafter, as a method for implementing UE power saving, discontinuous reception (DRX) will be described.

The procedure of the UE related to the DRX may be summarized as Table 5.

TABLE 5

| | Type of signals | UE procedure |
|---|---|---|
| Step 1 | RRC signalling | Receive DRX configuration |
| | (MAC-CellGroupConfig) | information |
| Step 2 | MAC CE | Receive DRX command |
| | ((Long) DRX command | |
| | MAC CE) | |
| Step 3 | | Monitor a PDCCH during an on- |
| | | duration of a DRX cycle |

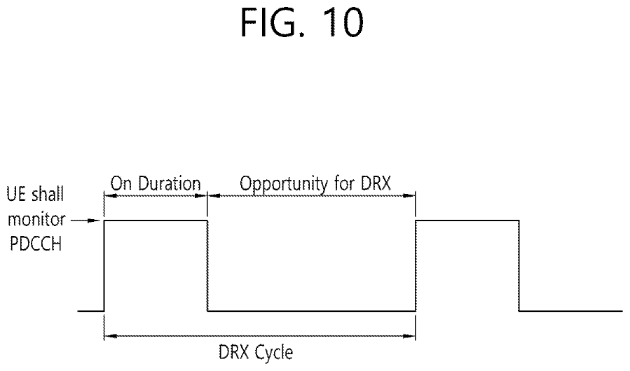

FIG. 10 shows an example of a DRX cycle, based on an embodiment of the present disclosure. The embodiment of FIG. 10 may be combined with various embodiments of the present disclosure.

Referring to FIG. 10, the UE uses discontinuous reception (DRX) in an RRC_IDLE state and an RRC_INACTIVE state in order to reduce power consumption. If the DRX is configured, the UE performs a DRX operation according to DRX configuration information. The UE operating as the DRX repeatedly turns its reception performance ON and OFF.

For example, if the DRX is configured, the UE attempts to receive a PDCCH, which is a downlink channel, only in a predetermined time period, and does not attempt to receive a PDCCH in the remaining time period. The time period during which the UE should attempt to receive the PDCCH is referred to as an on-duration, and the on-duration is defined once per DRX cycle.

The UE may receive DRX configuration information from the gNB through RRC signaling and operate as DRX through a reception of the (long) DRX command MAC CE.

The DRX configuration information may be included in MAC-CellGroupConfig. The MAC-CellGroupConfig IE is used to configure MAC parameters for a cell group, including DRX.

The DRX Command MAC CE or the long DRX Command MAC CE is identified by a MAC PDU subheader with LCID. It has a fixed size with zero bits.

Table 6 shows an example of values of LCID for DL-SCH.

TABLE 6

| Index | LCID values |
|---|---|
| 111011 | Long DRX Command |
| 111100 | DRX Command |

The PDCCH monitoring operation of the UE is controlled by DRX and bandwidth adaptation (BA). Meanwhile, If DRX is configured, the UE does not have to continuously monitor a PDCCH. Meanwhile, DRX is characterized by the following.
On-duration: duration that the UE waits for, after waking up, to receive a PDCCH. If the UE successfully decodes a PDCCH, the UE stays awake and starts an inactivity timer.
Inactivity timer: duration that the UE waits to successfully decode a PDCCH, from the last successful decoding of a PDCCH, failing which it may go back to sleep. The UE shall restart the inactivity timer after a single successful decoding of a PDCCH for the first transmission only (i.e., not for retransmissions).
Retransmission timer: duration until a retransmission may be expected;
Cycle: specifies the periodic repetition of the on-duration followed by a possible period of inactivity.

Next, DRX described in the MAC layer will be described. The MAC entity used below may be expressed as a UE or a MAC entity of the UE.

The MAC entity may be configured by RRC with a DRX functionality that controls the UE's PDCCH monitoring activity for the MAC entity's C-RNTI, CS-RNTI, TPC-PUCCH-RNTI, TPC-PUSCH-RNTI, and TPC-SRS-RNTI. When using DRX operation, the MAC entity shall also monitor a PDCCH. When in RRC_ CONNECTED, if DRX is configured, the MAC entity may monitor a PDCCH discontinuously using the DRX operation. Otherwise, the MAC entity shall monitor a PDCCH continuously.

RRC controls DRX operation by configuring parameters related to DRX configuration information.

If a DRX cycle is configured, an active time includes the time while:
drx-onDurationTimer or drx-InactivityTimer or drx-RetransmissionTimerDL or drx-RetransmissionTimerUL or ra-ContentionResolutionTimer is running; or
a scheduling request is sent on a PUCCH and is pending; or
a PDCCH indicating a new transmission addressed to the C-RNTI of the MAC entity has not been received after successful reception of a random access response for the random access preamble not selected by the MAC entity among the contention-based random access preamble.

If DRX is configured, the MAC entity shall:
1> if a MAC PDU is transmitted in a configured uplink grant:
2> start the drx-HARQ-RTT-TimerUL for the corresponding HARQ process immediately after the first repetition of the corresponding PUSCH transmission;
2> stop the drx-RetransmissionTimerUL for the corresponding HARQ process.
1> if a drx-HARQ-RTT-TimerDL expires:
2> if the data of the corresponding HARQ process was not successfully decoded:
3> start the drx-RetransmissionTimerDL for the corresponding HARQ process.
1> if a drx-HARQ-RTT-TimerUL expires:
2> start the drx-RetransmissionTimerUL for the corresponding HARQ process.
1> if a DRX Command MAC CE or a Long DRX Command MAC CE is received:
2> stop drx-onDurationTimer;
2> stop drx-InactivityTimer.
1> if drx-InactivityTimer expires or a DRX Command MAC CE is received:
2> if the Short DRX cycle is configured:
3> start or restart drx-ShortCycleTimer;
3> use the Short DRX Cycle.
2> else:
3> use the Long DRX cycle.
1> if drx-ShortCycleTimer expires:
2> use the Long DRX cycle.
1> if a Long DRX Command MAC CE is received:
2> stop drx-ShortCycleTimer;
2> use the Long DRX cycle.
1> if the Short DRX Cycle is used, and [(SFN×10)+subframe number] modulo (drx-ShortCycle)=(drx-StartOffset) modulo (drx-ShortCycle); or
1> if the Long DRX Cycle is used, and [(SFN×10)+subframe number] modulo (drx-LongCycle)=drx-StartOffset:
2> if drx-SlotOffset is configured:
3> start drx-onDurationTimer after drx-SlotOffset.
2> else:
3> start drx-onDurationTimer.
1> if the MAC entity is in Active Time:
2> monitor the PDCCH;
2> if the PDCCH indicates a DL transmission or if a DL assignment has been configured:
3> start the drx-HARQ-RTT-TimerDL for the corresponding HARQ process immediately after the corresponding PUCCH transmission;
3> stop the drx-RetransmissionTimerDL for the corresponding HARQ process.
2> if the PDCCH indicates a UL transmission:
3> start the drx-HARQ-RTT-TimerUL for the corresponding HARQ process immediately after the first repetition of the corresponding PUSCH transmission;
3> stop the drx-RetransmissionTimerUL for the corresponding HARQ process.
2> if the PDCCH indicates a new transmission (DL or UL):
3> start or restart drx-InactivityTimer.
1> else (i.e., not part of the Active Time):
2> not transmit type-0-triggered SRS.
1> if CQI masking (cqi-Mask) is setup by upper layers:
2> if drx-onDurationTimer is not running:
3> not report CSI on PUCCH.
1> else:
2> if the MAC entity is not in Active Time:
3> not report CSI on PUCCH.

Regardless of whether the MAC entity is monitoring PDCCH or not, the MAC entity transmits HARQ feedback and type-1-triggered SRS when such is expected.

The MAC entity needs not to monitor the PDCCH if it is not a complete PDCCH occasion (e.g., the Active Time starts or expires in the middle of a PDCCH occasion).

In the present disclosure, the term “configuration/configured or definition/defined” may be interpreted as being (pre-)configured from the base station or the network (through predefined signaling (e.g., SIB, MAC signaling, RRC signaling)). For example, “A may be configured” may include “that the base station or the network (pre-)configures/defines or informs A to the UE”. Alternatively, the term “configuration/configured or definition/defined” may be interpreted as being pre-configured or pre-defined in the system. For example, “A may be configured” may include “that A is pre-configured/defined in the system”.

Meanwhile, in order to reduce power consumption of the UE in SL communication, the UE may not always monitor a transmission channel. That is, the UE may detect an SL signal or channel to be received by monitoring a transmission channel only if reception of a PSCCH and/or PSSCH is required, and the UE may perform decoding for the SL signal or channel.

Meanwhile, a DRX cycle may include (i) an active time when the UE monitors a transmission channel in an awake mode and, if necessary, detects/decodes an SL channel, and (ii) an inactive time when the UE is in a sleep mode (i.e., the UE does not need to monitor a channel).

For example, the active time may include (i) an OnDurationTimer duration in which the UE should be awake at the beginning of the DRX cycle, (ii) an InActivityTimer duration in which the UE should be additionally awake due to a high possibility of transmission of an additional SL signal or channel by other UE(s), after the OnDurationTimer expires, (iii) a RetransmissionTimer duration in which the UE should be additionally awake due to a high possibility of additional retransmission by another UE, after a certain transmission, etc.

For example, the inactive time may be all durations except for the active time within a DRX cycle representing an entire DRX duration. In particular, for example, the inactive time may include a HARQ-RTT-Timer duration configured to secure a processing time related to HARQ-based retransmission and a time required for retransmission.

For example, according to the length of a DRX cycle, the DRX cycle may include (i) a ‘DRX long cycle’ with a relatively long cycle length and (ii) a ‘DRX short cycle’ with a relatively short cycle length. For example, the start of the DRX long cycle and the DRX short cycle may be expressed as an offset value with respect to a reference timing. Herein, for example, the offset value may be StartOffset expressed as the number of subframe units. For example, the offset value may be SlotOffset expressed as the number of slot units.

Meanwhile, if DRX cycle configurations are different between UEs in a group in which groupcast communication is performed, a UE B may not receive data transmitted by a UE A during an active time period of the UE B. Accordingly, the DRX cycle need to be aligned between UEs in a group in which groupcast communication is performed.

Based on various embodiments of the present disclosure, in case that UEs in a group for SL groupcast perform DRX operations, a method for aligning operations related to the DRX cycle of each UE and device(s) supporting the same are proposed such that SL communication between UEs can be smoothly performed. In the present disclosure, DRX may refer to SL DRX.

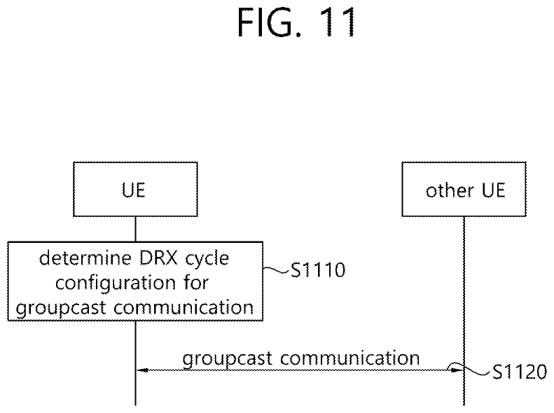

FIG. 11 shows a procedure for a UE to perform groupcast communication based on a DRX cycle configuration, based on an embodiment of the present disclosure. The embodiment of FIG. 11 may be combined with various embodiments of the present disclosure.

Referring to FIG. 11, in step S1110, the UE may determine/select a DRX cycle configuration for groupcast communication. For example, the UE may determine/select a specific DRX cycle configuration from among a plurality of candidate DRX cycle configurations. For example, the UE may determine/select a specific DRX cycle configuration from among a plurality of candidate DRX cycle configurations, based on various embodiments of the present disclosure. Alternatively, for example, although not shown in FIG. 11, the UE may receive the specific DRX cycle configuration from the base station/network. In this case, the base station/network may determine/select a specific DRX cycle configuration from among a plurality of candidate DRX cycle configurations, and the base station/network may transmit index/information related to the specific DRX cycle configuration to the UE.

For example, if DRX cycle configurations are different between UEs in a group in which groupcast communication is performed, the UE B may not be able to receive data transmitted by the UE A during an active time period of the UE B. To solve this problem, a DRX cycle including an active time and an inactive time may be configured to align each other among all UEs in a group. To this end, for example, there may be a plurality of candidate DRX cycle configurations pre-defined or configured by a higher layer or pre-configured, and a higher layer may configure index/information related to a specific DRX cycle configuration among the plurality of candidate DRX cycle configurations to UEs in a group. For example, there may be a plurality of candidate DRX cycle configurations pre-defined or configured by a higher layer or pre-configured, and a UE representing a group may select a specific DRX cycle configuration from among the plurality of candidate DRX cycle configurations, and the UE representing the group may transmit index/information related to the specific DRX cycle configuration to UEs in the group. For example, the UE representing the group may be a group header UE. For example, there may be a plurality of candidate DRX cycle configurations pre-defined or configured by a higher layer or pre-configured, and the base station/network may select a specific DRX cycle configuration from among the plurality of candidate DRX cycle configurations, and the base station/network may transmit index/information related to the specific DRX cycle configuration to UEs in a group. For example, there may be a plurality of candidate DRX cycle configurations pre-defined or configured by a higher layer or pre-configured, and the UE may select index/information related to a specific DRX cycle configuration from among the plurality of candidate DRX cycle configurations based on a predefined (implicit) rule.

For example, the index/information related to the DRX cycle configuration may be determined/selected/configured based on an ID of the group. For example, the index/information related to the DRX cycle configuration may be determined/selected/configured based on a zone ID of a zone to which the group belongs. For example, the index/information related to the DRX cycle configuration may be determined/selected/configured based on an ID of the UE representing the group. For example, the index/information related to the DRX cycle configuration may be determined/selected/configured based on the number of UEs belonging to the group. Through this, independent or different DRX cycle configurations may be used between different groups or between UEs belonging to different groups.

For example, if the group header UE in the group selects the index/information related to the DRX cycle configuration to be used by group member UE(s), the group header UE may transmit/share the index related to the selected DRX cycle configuration to group member UE(s). In this case, the group header UE may transmit the index/information related to the selected DRX cycle configuration through SCI indicating a destination ID as a group ID, by using a specific DRX resource pool. For example, the group header UE may transmit SCI including the destination ID (i.e., group ID) and the index/information related to the selected DRX cycle configuration, by using the specific DRX resource pool. Herein, for example, the specific DRX resource pool may be a DRX resource pool that is defined for such as transmission of broadcast data as an initial operation or a fallback operation and may be commonly used by all DRX UEs. Accordingly, the group member UE(s) of the group can receive the destination ID (i.e., group ID) and the index/information related to the DRX cycle configuration through the SCI on the DRX resource pool always being monitored, and the group member UE(s) of the group may perform the DRX operation based on the DRX cycle configuration.

For example, the DRX cycle configuration may be determined/selected/configured based on the number of UEs belonging to the group (i.e., size of the group). In this case, timer value(s) such as OnDurationTimer, InactivityTimer, and/or RetransmissionTimer included in an active time within a DRX cycle may be determined/selected/set based on the size of the group. For example, if the size of the group is large, the timer value(s) may be set to a relatively large value, and if the size of the group is small, the timer value(s) may be set to a relatively small value. For example, if the size of the group is greater than a first threshold, the timer value (s) may be set to a value greater than a second threshold, and if the size of the group is less than a third threshold, the timer value(s) may be set to a value less than a fourth threshold. For example, the first threshold may be greater than or equal to the third threshold. For example, the second threshold may be greater than or equal to the fourth threshold. For example, the first to fourth thresholds may be predefined for the UE. For example, the first to fourth thresholds may be configured or pre-configured for the UE. For example, the base station/network may transmit information related to the first to fourth thresholds to the UE. By doing this, even if the number of UEs belonging to the group is large, an active time period required for SL transmission and reception can be sufficiently secured.

For example, for the DRX cycle configuration selected according to the size of the group, UEs belonging to the group may use different sub-time periods by dividing an active time period into a plurality of TDMed sub-time periods. In this case, since different sub-time periods can be used among UEs belonging to the group, congestion in groupcast communication can be minimized. For example, a sub-time period to be used by a specific UE in the group may be determined/configured/selected based on at least one of a member ID, a source ID, and/or a destination ID in the group. For example, a sub-time period to be used by a specific UE in the group may be determined/configured/selected based on the ID information (e.g., at least one of the member ID, the source ID, and/or the destination ID in a group) and a zone ID according to a region in which UEs in the group move. In this way, if the UE uses the zone ID information mixed with the ID information, it is possible to avoid a case in which a specific UE is always placed in a disadvantageous situation when selecting a transmission resource by always using only a specific time domain within an active time period. That is, the transmission resource region can be randomized.

For example, the group header UE may adjust/determine the size of the group based on the selected DRX cycle configuration. For example, after the group header UE selects the DRX cycle configuration corresponding to ‘group size=N’ and shares it with the group member UE(s), if other UEs additionally want to join the group, the group header UE may reject join requests of other UEs, and the group header UE may maintain the size of the group within the maximum required size.

For example, as in the case described above, if more group member UEs join the group than the size of the group that the DRX cycle configuration selected by the group header UE can accommodate, the group header UE may select or be configured with a plurality of DRX cycle configurations. In this case, for example, member UE(s) belonging to a first group may use a first DRX cycle configuration, and member UE(s) belonging to a second group may use a second DRX cycle configuration. In this case, for example, a group member UE may determine/configure/select a DRX cycle configuration to be used based on at least one of a member ID, a source ID, and/or a destination ID within the group. For example, a group member UE may determine/configure/select a DRX cycle configuration to be used by itself, based on the ID information (e.g., at least one of the member ID, the source ID, and/or the destination ID within the group) and a zone ID according to a region in which UEs in the group move.

In step S1120, the UE may perform groupcast communication based on the DRX cycle configuration for groupcast communication.

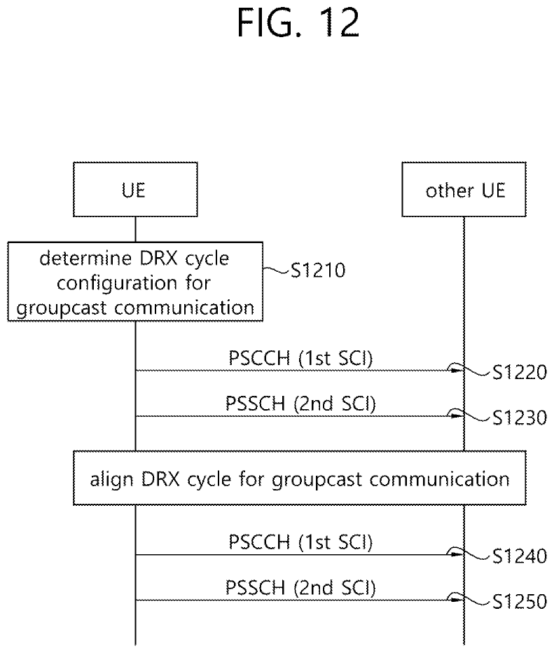

FIG. 12 shows a procedure for a UE to perform groupcast communication based on a DRX cycle configuration, based on an embodiment of the present disclosure. The embodiment of FIG. 12 may be combined with various embodiments of the present disclosure. FIG. 12 shows a specific example in which a UE transmits information/index related to an SL DRX configuration for groupcast to another UE among the embodiments of FIG. 11.

Referring to FIG. 12, in step S1210, the UE may determine/select a DRX cycle configuration for groupcast communication. A specific embodiment in which the UE determines/selects the DRX cycle for groupcast communication may refer to FIG. 11.

In step S1220, the UE may transmit first SCI through a PSCCH. For example, the first SCI may include information for scheduling a PSSCH and/or second SCI.

In step S1230, the UE may transmit the second SCI through the PSSCH. Additionally, for example, the UE may transmit data (e.g., MAC PDU or TB) through the PSSCH. For example, the second SCI may include a group ID (e.g., destination ID) and information/index related to an SL DRX configuration. Through this, the SL DRX configuration can be shared among UEs in the group, and the DRX cycle for groupcast communication can be aligned between UEs in the group.

In step S1240, the UE may transmit first SCI through a PSCCH based on the SL DRX configuration. For example, the first SCI may include information for scheduling a PSSCH and/or second SCI.

In step S1250, the UE may transmit the second SCI through the PSSCH based on the SL DRX configuration. Additionally, for example, the UE may transmit data (e.g., MAC PDU or TB) through the PSSCH based on the SL DRX configuration.

Based on various embodiments of the present disclosure, when UEs performing DRX operations perform groupcast communication, proposed are a method for aligning DRX cycle configurations between group member UEs such that SL communication between group member UEs can be performed, and device(s) supporting the same.

Based on the above-described embodiment, the SL DRX configuration may be shared between UEs within the group. Therefore, SL communication can be performed between UEs performing power saving within the group. Furthermore, since the SL DRX configurations can be configured differently for each group, interference between groups in which groupcast communication is performed can be minimized.

Based on various embodiments of the present disclosure, a method for a UE to perform SL communication based on DRX and device(s) supporting the same are proposed.

For example, the UE performing SL communication based on resource allocation mode 1 may receive a dynamic grant (DG) resource and/or a configured grant (CG) resource configured by the base station. For example, the UE may receive information related to the DG resource and/or information related to the CG resource from the base station. For example, the CG resource may include a CG type 1 resource or a CG type 2 resource. In the present disclosure, the DG resource may be a resource that the base station configures/allocates to the UE through DCI. In the present disclosure, the CG resource may be a (periodic) resource configured/allocated by the base station to the UE through DCI and/or an RRC message. For example, in the case of the CG type 1 resource, the base station may transmit an RRC message including information related to the CG resource to the UE. For example, in the case of the CG type 2 resource, the base station may transmit an RRC message including information related to the CG resource to the UE, and the base station may transmit DCI including information related to activation or release of the CG resource to the UE.

For example, the UE performing SL communication based on resource allocation mode 2 may select a resource for SL transmission through channel sensing within a resource pool configured by the base station. For example, the resource may include a dynamic resource or an SPS resource. In the present disclosure, the dynamic resource may be a resource that a UE selects within the resource pool based on sensing. In the present disclosure, the SPS resource may be a (periodic) resource that the UE selects within the resource pool based on sensing.

Meanwhile, a transmission period and data amount of data to be transmitted may be different for each UE. Due to this, it is almost impossible to predict an ON duration and an OFF duration in consideration of these various traffics with one DRX cycle described above. Therefore, a method for implementing the DRX function more efficiently is to configure DRX cycles suitable for each resource type according to the SL resources, and configure one DRX cycle by aggregating each DRX cycle suitable for the SL resources to determine the final ON duration and OFF duration. For convenience of description, one DRX cycle generated by aggregating a plurality of DRX cycles may be referred to as a global DRX cycle. In the present disclosure, a DRX cycle used for SL communication may be referred to as an SL DRX cycle or a DRX cycle.

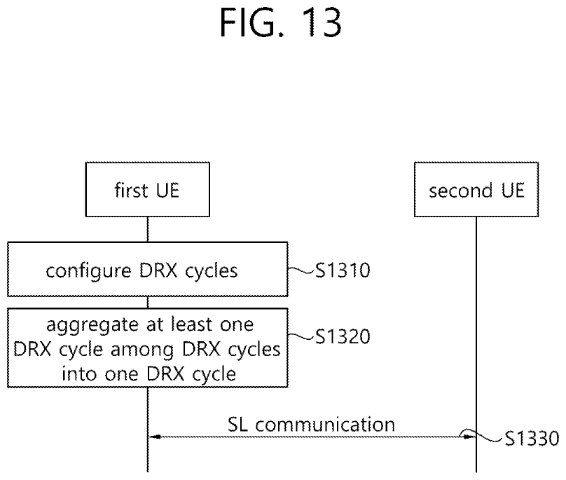

FIG. 13 shows a method for a UE to perform aggregation for DRX cycles, based on an embodiment of the present disclosure. The embodiment of FIG. 13 may be combined with various embodiments of the present disclosure.

In the embodiment of FIG. 13, a first UE may be an RX UE or a TX UE, and a second UE may be a TX UE or an RX UE.

Referring to FIG. 13, in step S1310, the first UE may configure a plurality of DRX cycles. For example, the first UE may receive information related to a plurality of DRX cycles from the base station. For example, the first UE may autonomously select/configure/determine a plurality of DRX cycles. For example, a plurality of DRX cycles may be predefined for the first UE. For example, a DRX cycle may be configured per SL process. For example, at least one of a DRX cycle related to the DG resource, a DRX cycle related to the CG type 1 resource, a DRX cycle related to the CG type 2 resource, a DRX cycle related to the dynamic resource, and/or a DRX cycle related to the SPS resource may be configured for the UE.

In step S1320, the first UE may aggregate at least one DRX cycle among the plurality of DRX cycles into one DRX cycle.

In step S1330, the first UE may perform SL communication (e.g., SL reception and/or SL transmission) based on the aggregated DRX cycle.

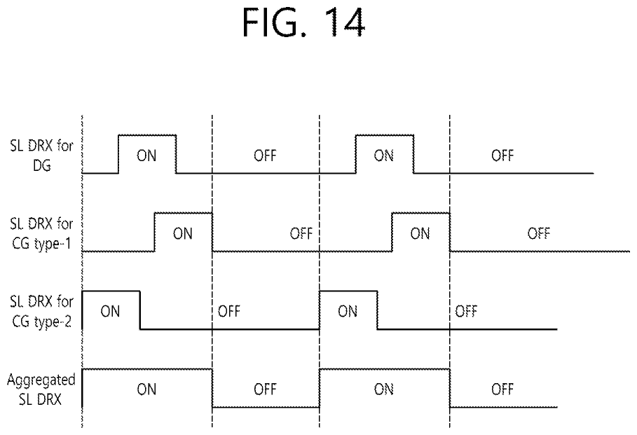

FIG. 14 shows an example of aggregation for DRX cycles, based on an embodiment of the present disclosure. The embodiment of FIG. 14 may be combined with various embodiments of the present disclosure.

Referring to FIG. 14, an ON duration of the aggregated DRX cycles may be derived by a logical OR operation of ON durations of each DRX cycle. Therefore, in order to maximize the power saving gain according to the final SL DRX cycle, the following operations may be performed.

In the present disclosure, a threshold may be predefined for the UE. In the present disclosure, a threshold may be pre-configured or configured for the UE by the base station/network. For example, the base station/network may transmit information related to a threshold to the UE. In the present disclosure, a threshold may be configured by a higher layer of the UE.

For example, if the number of individual DRX cycles per SL process is greater than the threshold, the UE may no longer perform aggregation for individual DRX cycles. For example, the UE may perform aggregation for as many DRX cycles as the number of less than or equal to the threshold, and the UE may perform SL communication (e.g., SL transmission and/or SL reception) based on the aggregated DRX cycle.

For example, the UE performing SL communication based on DRX may transmit information related to its own DRX cycle aggregation capability to the other UE(s) or the base station. Through this, by aggregating individual DRX cycles, it is possible to prevent power consumption of the UE from exceeding a specific threshold.

For example, the UE performing SL communication based on DRX may transmit, to the other UE(s) or the base station, (i) information related to a DRX cycle aggregation capability of the UE and (ii) information related to the number of individual DRX cycles currently being aggregated by the UE. Through this, the other UE(s) or the base station may determine, based on the information, the number of SL processes that can be additionally generated within the DRX cycle aggregation capability of the UE.

For example, the UE performing SL communication based on DRX may receive SL information (e.g., PSCCH, PSSCH, PSFCH, etc.) from a peer UE based on a resource related to an SL process. In this case, for example, the UE may expect/determine that ON durations of each DRX cycle related to each SL process partially or entirely overlap with each other. For example, the UE may expect/determine that ON durations of each DRX cycle related to each SL process are adjacent to each other. For example, the TX UE may perform SL transmission such that ON durations of each DRX cycle related to each SL process partially or entirely overlap with each other. For example, the TX UE may perform SL transmission such that ON durations of each DRX cycle related to each SL process are adjacent to each other.

For example, initial transmission, retransmission, and/or HARQ-based retransmission, etc. for each SL process may all be performed within ON durations of each DRX cycle related to each SL process, and each DRX cycle based on burst transmission may not overlap with each other. That is, if an OFF duration is very long, the aggregated DRX cycle for individual DRX cycles operating as described above may be derived in the form of composed of short DRX cycles.

For example, the UE operating based on resource allocation mode 1 may expect/determine that the base station configures a DL resource and an SL resource such that a DL DRX cycle including DCI allocating a resource related to the SL process and the aggregated DRX cycle partially or entirely overlap each other. For example, the UE operating based on resource allocation mode 1 may expect/determine that the base station configures a DL resource and an SL resource such that a DL DRX cycle including DCI allocating a resource related to the SL process and the aggregated DRX cycle are adjacent to each other.

In the present disclosure, proposed are a method for the UE to configure the final DRX cycle by aggregating DRX cycles individually configured for each SL process, a method for configuring individual SL process to maximize power saving gain by aggregated DRX cycles and configuring DRX cycles accordingly, and device(s) supporting the same.

Meanwhile, since a periodic ON/OFF duration is applied within the DRX cycle, DRX-based communication may be suitable for providing a service requiring periodic data transmission. On the other hand, in the case of a service requiring aperiodic data transmission, if the UE periodically applies the DRX cycle, the power saving effect may also decrease, and the data reception success rate of the UE may also decrease. In order to solve the above disadvantages, a wake-up signal (WUS) may be used. For example, the WUS may be configured with a specific sequence, and the UE performing SL communication based on DRX may perform detection for the specific sequence. For example, the UE performing SL communication based on DRX may operate in a power saving mode by default, and the UE may perform only WUS detection by using minimum power in the power saving mode. For example, if the UE detects the WUS, the UE may perform monitoring of a transmission channel and decoding of the detected PSCCH/PSSCH.

Based on various embodiments of the present disclosure, a method for a UE to perform SL communication based on DRX and device(s) supporting the same are proposed.

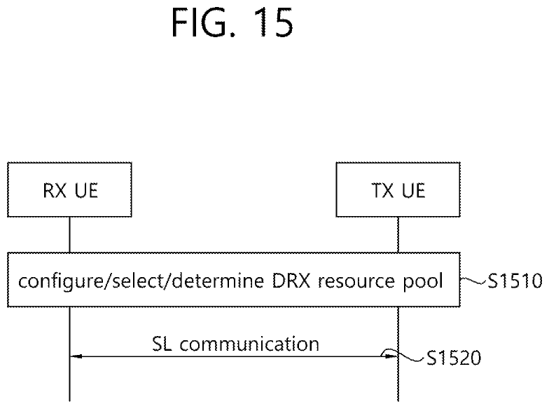

FIG. 15 shows a procedure for a UE to perform SL communication based on a DRX resource pool, based on an embodiment of the present disclosure. The embodiment of FIG. 15 may be combined with various embodiments of the present disclosure.

Referring to FIG. 15, in step S1510, the TX UE and/or the RX UE may configure/select/determine a DRX resource pool. For example, the TX UE and/or the RX UE may configure/select/determine the DRX resource pool, based on various embodiments of the present disclosure.

For example, all UEs performing SL communication may transmit and receive the WUS or information by using a resource within the DRX resource pool. On the other hand, for example, all UEs performing SL communication cannot transmit/receive the WUS or information by using a resource outside the DRX resource pool. For example, the information may be a message, a service, a packet, data, control information for DRX reception, etc.

For example, the DRX resource pool may consist of the relatively small number of burst time resources in the time domain, and the DRX resource pool may consist of the relatively large number of frequency resources or wide bandwidth frequency resources in the frequency domain. For example, compared to a general resource pool, the DRX resource pool may include the relatively small number of burst time resources in the time domain, and the DRX resource pool may include the relatively large number of frequency resources or wide bandwidth frequency resources in the frequency domain. For example, the DRX resource pool may consist of the relatively small number of continuous frequency resources or narrow bandwidth frequency resources in the frequency domain, and the DRX resource pool may be consist of the relatively large number of burst time resources in the time domain. For example, compared to a general resource pool, the DRX resource pool may include the relatively small number of continuous frequency resources or narrow bandwidth frequency resources in the frequency domain, and the DRX resource pool may include the relatively large number of burst time resources in the time domain.

For example, the DRX resource pool may be predefined for the UE. For example, the DRX resource pool may be configured by a higher layer of the UE. For example, the DRX resource pool may be configured or pre-configured for the UE. For example, the base station/network may transmit information related to the DRX resource pool to the UE. In the present disclosure, the higher layer may include an application layer or a V2X layer.

For example, the DRX resource pool may be predefined for the UE to use only one or more specific subchannels. For example, the DRX resource pool may be configured by a higher layer of the UE to use only one or more specific subchannels. For example, the DRX resource pool may be configured or pre-configured for the UE to use only one or more specific subchannels. For example, the base station/network may transmit, to the UE, information regarding one or more specific subchannels related to the DRX resource pool.

For example, UEs that transmit and receive broadcast-related information may use a common DRX resource pool. For example, UEs may perform broadcast communication based on the common DRX resource pool. In the present disclosure, the information may include at least one of a PSCCH (e.g., control information), a PSSCH (e.g., control information and/or data), a PSFCH (e.g., feedback), a MAC PDU, a packet, a service, and/or a message.

For example, UEs that transmit and receive groupcast-related information in a group may use a common DRX resource pool. For example, UEs belonging to a first group may perform groupcast communication based on a first DRX resource pool.

For example, different DRX resource pools may be used between different groups. For example, different DRX resource pools may be non-overlapping DRX resource pools. For example, UEs belonging to a first group may perform groupcast communication based on a first DRX resource pool, and UEs belonging to a second group may perform groupcast communication based on a second DRX resource pool. Specifically, for example, the UE may be configured to determine a DRX resource pool to be used for groupcast communication based on at least one of a location, a zone ID, and/or a group ID of a group to which the UE belongs. For example, a first UE belonging to a first group may determine to use a first DRX resource pool for groupcast communication based on at least one of a location, a zone ID, and/or a group ID of the first group. For example, a second UE belonging to a second group may determine to use a second DRX resource pool for groupcast communication based on at least one of a location, a zone ID, and/or a group ID of the second group. For example, the first DRX resource pool may be different from the second DRX resource pool.

For example, UEs that transmit and receive unicast-related information may configure/determine a DRX resource pool based on at least one of a source ID, a destination ID, a zone ID, and/or a UE ID. Through this, different DRX resource pools may be used between UE pairs performing different unicast communications. For example, if first unicast communication is performed between a first UE and a second UE and second unicast communication is performed between a third UE and a fourth UE, a DRX resource pool used for the first unicast communication may be different from a DRX resource pool used for the second unicast communication. For example, if first unicast communication is performed between a first UE and a second UE and second unicast communication is performed between the first UE and a third UE, a DRX resource pool used for the first unicast communication may be different from a DRX resource pool used for the second unicast communication.

For example, the TX UE may transmit an S-SSB to the RX UE on a resource within a DRX resource pool, and the RX UE may detect/monitor the S-SSB on the resource within the DRX resource pool. For example, the RX UE may be a UE that performs SL communication based on DRX.

For example, the TX UE may transmit an S-SSB to the RX UE on a resource outside a DRX resource pool. Specifically, for example, the TX UE transmits the S-SSB to the RX UE on a resource adjacent to the DRX resource pool in the time domain such that the RX UE can detect the S-SSB by monitoring a transmission channel during an ON duration. In this case, the RX UE may detect the S-SSB transmitted by the TX UE during the ON duration of the DRX cycle. For example, the RX UE may be a UE that performs SL communication based on DRX.

For example, the UE operating in a power saving mode or the UE operating in DRX may perform an SL mode 2 operation (e.g., partial sensing operation or random selection operation) on resources in the DRX resource pool. On the other hand, the UE operating in a power saving mode or the UE operating in DRX may not perform an SL mode 2 operation (e.g., partial sensing operation or random selection operation) on resources outside the DRX resource pool.

For example, the TX UE may transmit important information by using a resource within the DRX resource pool. For example, important information may be important information that the RX UE should receive with very high reliability and/or very low time latency, such as a basic safety message (BSM) or a broadcast message. For example, if the TX UE transmits important information by using the resource within the DRX resource pool, the RX UE performing SL communication based on DRX can always perform channel monitoring for the DRX resource pool, and the probability of detection failure for the important information can be minimized.

For example, the TX UE may transmit unicast-related information or groupcast-related information by using a resource within an SL resource pool that does not overlap with the DRX resource pool.

For example, the WUS may inform the UE of a time when the UE performing SL communication based on DRX should wake up from a sleep mode and monitor a transmission channel. In this case, the TX UE may transmit an S-SSB at a later time than the WUS. For example, the TX UE may transmit the S-SSB at a time after a time offset/interval from a time when the WUS is transmitted. For example, the time offset/interval may be predefined for the UE. For example, the time offset/interval may be configured by a higher layer of the UE. For example, the time offset/interval may be configured or pre-configured for the UE. For example, the base station/network may transmit information related to the time offset/interval to the UE.

For example, the WUS may signal whether an S-SSB is transmitted in the following time domain. For example, the TX UE may transmit the WUS indicating whether an S-SSB is transmitted.

For example, the TX UE may transmit an index for a specific DRX cycle among a plurality of DRX cycles to the RX UE. For example, if the RX UE receives the index for the specific DRX cycle, the RX UE may prepare a power saving operation. For example, the plurality of DRX cycles may be predefined for the UE. For example, the plurality of DRX cycles may be configured by a higher layer of the UE. For example, the plurality of DRX cycles may be configured or pre-configured for the UE. For example, the base station/network may transmit information related to the plurality of DRX cycles to the UE. For example, the RX UE may be a UE that performs SL communication based on DRX.

For example, the base station/network may transmit an index for a specific DRX cycle among a plurality of DRX cycles to the RX UE. For example, if the RX UE receives the index for the specific DRX cycle, the RX UE may prepare a power saving operation. For example, the plurality of DRX cycles may be predefined for the UE. For example, the plurality of DRX cycles may be configured by a higher layer of the UE. For example, the plurality of DRX cycles may be configured or pre-configured for the UE. For example, the base station/network may transmit information related to the plurality of DRX cycles to the UE. For example, the RX UE may be a UE that performs SL communication based on DRX.

For example, a period of a DRX cycle used for SL communication may be configured as an integer multiple of a TDD-UL-DL-Configuration period configured/defined by the base station/network in Uu link. In this case, for example, the RX UE may (autonomously) select/configure/determine the period of the DRX cycle as the integer multiple of the TDD-UL-DL-Configuration period configured/defined by the network. For example, the integer multiple may be predefined for the UE. For example, the integer multiple may be configured by a higher layer of the UE. For example, the integer multiple may be configured or pre-configured for the UE. For example, the base station/network may transmit information related to the integer multiple to the UE. For example, the RX UE may be a UE that performs SL communication based on DRX.

For example, if a plurality of SL resource pools are configured for the UE, the TX UE or the RX UE may inform another UE of which SL resource pool the DRX cycle used by the TX UE or the RX UE belongs to. To this end, the TX UE or the RX UE may transmit SCI including information (e.g., resource pool index) related to a resource pool to which a specific DRX cycle is applied to another UE. For example, the RX UE may be a UE that performs SL communication based on DRX. For example, the TX UE may be a UE that performs SL communication based on DRX.

In step S1520, the TX UE and the RX UE may perform SL communication based on the DRX resource pool.

In the present disclosure, proposed are a method for configuring a DRX resource pool and always monitoring resources in the DRX resource pool or applying a DRX cycle, and device(s) supporting the same, in order for the DRX operation UE to receive data with a minimum reception failure probability. In addition, proposed are a method for exchanging information related to a period of a DRX cycle and information related to a resource pool to which the DRX cycle is applied between UEs, and device(s) supporting the same.

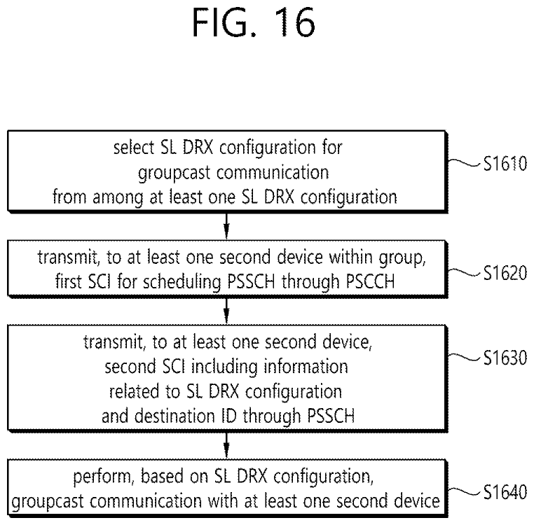

FIG. 16 shows a method for performing wireless communication by a first device, based on an embodiment of the present disclosure. The embodiment of FIG. 16 may be combined with various embodiments of the present disclosure.

Referring to FIG. 16, in step S1610, the first device may select a sidelink (SL) discontinuous reception (DRX) configuration for groupcast communication from among at least one SL DRX configuration. For example, the SL DRX configuration may include information related to a DRX cycle and information related to an active time. In step S1620, the first device may transmit, to at least one second device within a group, first sidelink control information (SCI) for scheduling a physical sidelink shared channel (PSSCH) through a physical sidelink control channel (PSCCH). In step S1630, the first device may transmit, to the at least one second device, second SCI including information related to the SL DRX configuration and a destination ID through the PSSCH. In step S1640, the first device may perform, based on the SL DRX configuration, the groupcast communication with the at least one second device.

For example, the SL DRX configuration may be selected based on an ID of the group from among the at least one SL DRX configuration.

For example, the SL DRX configuration may be selected based on an ID of a zone to which the group belongs from among the at least one SL DRX configuration.

For example, the SL DRX configuration may be selected based on a size of the group from among the at least one SL DRX configuration. For example, as the size of the group increases, the active time may be configured as a larger value.

For example, a size of the group may be determined based on the SL DRX configuration. For example, a number of devices within the group may not be allowed to exceed the size of the group related to the SL DRX configuration.

For example, the active time may be divided into N sub-active times, and N may be a positive integer. For example, a device within the group may be allowed to use at least one sub-active time among the N sub-active times based on an ID of the device. For example, a device within the group may be allowed to use at least one sub-active time among the N sub-active times based on an ID of the device and an ID of a zone to which the device belongs. For example, the ID of the device may be at least one of a member ID of the device, a source ID of the device, or a destination ID of the device.

For example, the information related to the SL DRX configuration may be an index representing the SL DRX configuration among the at least one SL DRX configuration.

For example, the second SCI including the information related to the SL DRX configuration and the destination ID may be transmitted based on a DRX resource pool, and the DRX resource pool may be a common resource pool used by devices performing DRX operations, and the SL DRX configuration may be a common SL DRX configuration used by devices within the group.

The proposed method can be applied to the device(s) based on various embodiments of the present disclosure. First, the processor 102 of the first device 100 may select a sidelink (SL) discontinuous reception (DRX) configuration for groupcast communication from among at least one SL DRX configuration. For example, the SL DRX configuration may include information related to a DRX cycle and information related to an active time. In addition, the processor 102 of the first device 100 may control the transceiver 106 to transmit, to at least one second device within a group, first sidelink control information (SCI) for scheduling a physical sidelink shared channel (PSSCH) through a physical sidelink control channel (PSCCH). In addition, the processor 102 of the first device 100 may control the transceiver 106 to transmit, to the at least one second device, second SCI including information related to the SL DRX configuration and a destination ID through the PSSCH. In addition, the processor 102 of the first device 100 may control the transceiver 106 to perform, based on the SL DRX configuration, the groupcast communication with the at least one second device.

Based on an embodiment of the present disclosure, a first device adapted to perform wireless communication may be provided. For example, the first device may comprise: one or more memories storing instructions; one or more transceivers; and one or more processors connected to the one or more memories and the one or more transceivers. For example, the one or more processors may execute the instructions to: select a sidelink (SL) discontinuous reception (DRX) configuration for groupcast communication from among at least one SL DRX configuration, wherein the SL DRX configuration includes information related to a DRX cycle and information related to an active time; transmit, to at least one second device within a group, first sidelink control information (SCI) for scheduling a physical sidelink shared channel (PSSCH) through a physical sidelink control channel (PSCCH); transmit, to the at least one second device, second SCI including information related to the SL DRX configuration and a destination ID through the PSSCH; and perform, based on the SL DRX configuration, the groupcast communication with the at least one second device.

Based on an embodiment of the present disclosure, an apparatus adapted to control a first user equipment (UE) may be provided. For example, the apparatus may comprise: one or more processors; and one or more memories operably connected to the one or more processors and storing instructions. For example, the one or more processors may execute the instructions to: select a sidelink (SL) discontinuous reception (DRX) configuration for groupcast communication from among at least one SL DRX configuration, wherein the SL DRX configuration includes information related to a DRX cycle and information related to an active time; transmit, to at least one second UE within a group, first sidelink control information (SCI) for scheduling a physical sidelink shared channel (PSSCH) through a physical sidelink control channel (PSCCH); transmit, to the at least one second UE, second SCI including information related to the SL DRX configuration and a destination ID through the PSSCH; and perform, based on the SL DRX configuration, the groupcast communication with the at least one second UE.

Based on an embodiment of the present disclosure, a non-transitory computer-readable storage medium storing instructions may be provided. For example, the instructions, when executed, may cause a first device to: select a sidelink (SL) discontinuous reception (DRX) configuration for groupcast communication from among at least one SL DRX configuration, wherein the SL DRX configuration includes information related to a DRX cycle and information related to an active time; transmit, to at least one second device within a group, first sidelink control information (SCI) for scheduling a physical sidelink shared channel (PSSCH) through a physical sidelink control channel (PSCCH); transmit, to the at least one second device, second SCI including information related to the SL DRX configuration and a destination ID through the PSSCH; and perform, based on the SL DRX configuration, the groupcast communication with the at least one second device.

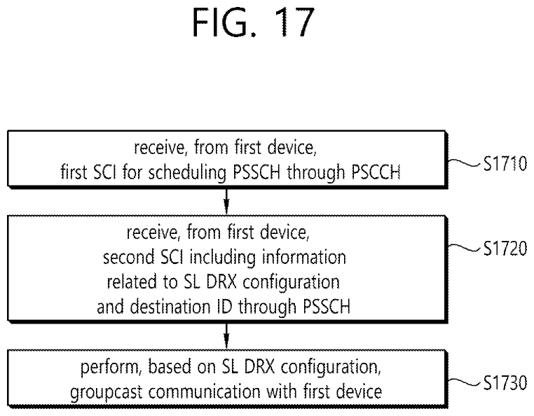

FIG. 17 shows a method for performing wireless communication by a second device, based on an embodiment of the present disclosure. The embodiment of FIG. 17 may be combined with various embodiments of the present disclosure.

Referring to FIG. 17, in step S1710, the second device may receive, from a first device, first sidelink control information (SCI) for scheduling a physical sidelink shared channel (PSSCH) through a physical sidelink control channel (PSCCH). In step S1720, the second device may receive, from the first device, second SCI including information related to a sidelink (SL) discontinuous reception (DRX) configuration and a destination ID through the PSSCH. In step S1730, the second device may perform, based on the SL DRX configuration, groupcast communication with the first device. For example, the SL DRX configuration may be selected by the first device for the groupcast communication from among at least one SL DRX configuration, and the SL DRX configuration may include information related to a DRX cycle and information related to an active time.

The proposed method may be applied to the device(s) based on various embodiments of the present disclosure. First, the processor 202 of the second device 200 may control the transceiver 206 to receive, from a first device, first sidelink control information (SCI) for scheduling a physical sidelink shared channel (PSSCH) through a physical sidelink control channel (PSCCH). In addition, the processor 202 of the second device 200 may control the transceiver 206 to receive, from the first device, second SCI including information related to a sidelink (SL) discontinuous reception (DRX) configuration and a destination ID through the PSSCH. In addition, the processor 202 of the second device 200 may control the transceiver 206 to perform, based on the SL DRX configuration, groupcast communication with the first device. For example, the SL DRX configuration may be selected by the first device for the groupcast communication from among at least one SL DRX configuration, and the SL DRX configuration may include information related to a DRX cycle and information related to an active time.

Based on an embodiment of the present disclosure, a second device adapted to perform wireless communication may be provided. For example, the second device may comprise: one or more memories storing instructions; one or more transceivers; and one or more processors connected to the one or more memories and the one or more transceivers. For example, the one or more processors may execute the instructions to: receive, from a first device, first sidelink control information (SCI) for scheduling a physical sidelink shared channel (PSSCH) through a physical sidelink control channel (PSCCH); receive, from the first device, second SCI including information related to a sidelink (SL) discontinuous reception (DRX) configuration and a destination ID through the PSSCH; and perform, based on the SL DRX configuration, groupcast communication with the first device. For example, the SL DRX configuration may be selected by the first device for the groupcast communication from among at least one SL DRX configuration, and the SL DRX configuration may include information related to a DRX cycle and information related to an active time.

Based on an embodiment of the present disclosure, an apparatus adapted to control a second user equipment (UE) may be provided. For example, the apparatus may comprise: one or more processors; and one or more memories operably connected to the one or more processors and storing instructions. For example, the one or more processors may execute the instructions to: receive, from a first UE, first sidelink control information (SCI) for scheduling a physical sidelink shared channel (PSSCH) through a physical sidelink control channel (PSCCH); receive, from the first UE, second SCI including information related to a sidelink (SL) discontinuous reception (DRX) configuration and a destination ID through the PSSCH; and perform, based on the SL DRX configuration, groupcast communication with the first UE. For example, the SL DRX configuration may be selected by the first UE for the groupcast communication from among at least one SL DRX configuration, and the SL DRX configuration may include information related to a DRX cycle and information related to an active time.

Based on an embodiment of the present disclosure, a non-transitory computer-readable storage medium storing instructions may be provided. For example, the instructions, when executed, may cause a second device to: receive, from a first device, first sidelink control information (SCI) for scheduling a physical sidelink shared channel (PSSCH) through a physical sidelink control channel (PSCCH); receive, from the first device, second SCI including information related to a sidelink (SL) discontinuous reception (DRX) configuration and a destination ID through the PSSCH; and perform, based on the SL DRX configuration, groupcast communication with the first device. For example, the SL DRX configuration may be selected by the first device for the groupcast communication from among at least one SL DRX configuration, and the SL DRX configuration may include information related to a DRX cycle and information related to an active time.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

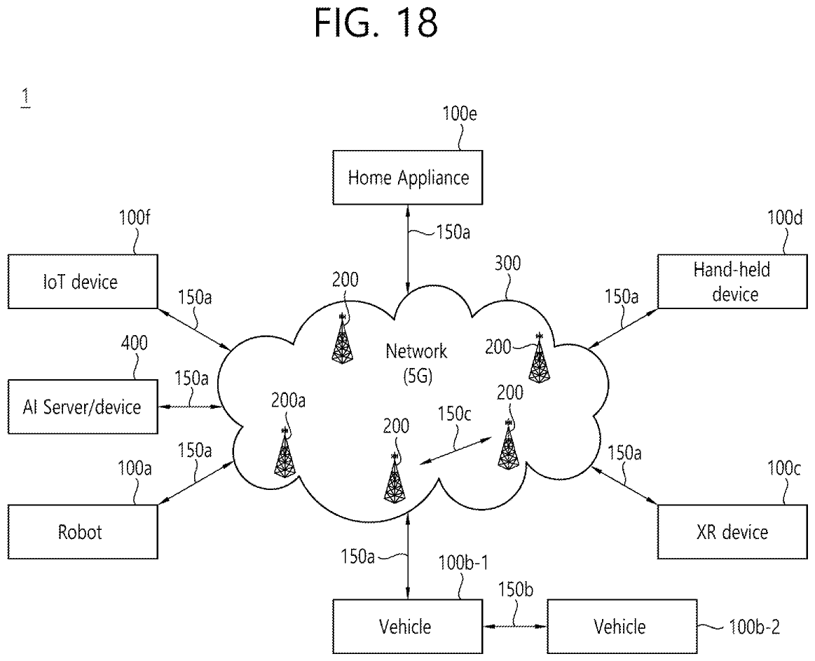

FIG. 18 shows a communication system 1, based on an embodiment of the present disclosure.

Referring to FIG. 18, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a B S/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (TAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

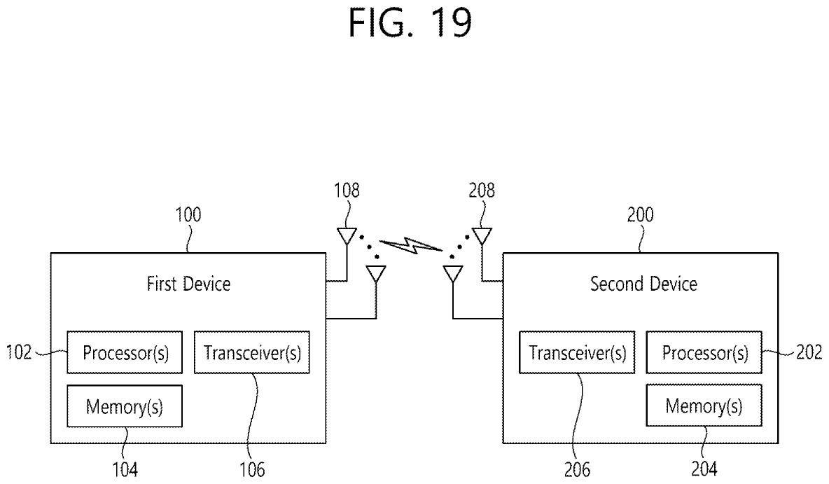

FIG. 19 shows wireless devices, based on an embodiment of the present disclosure.

Referring to FIG. 19, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 18.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

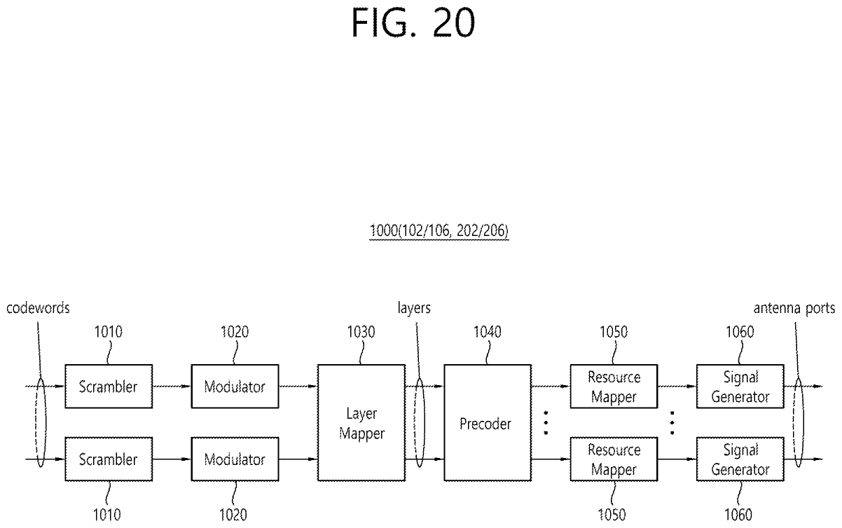

FIG. 20 shows a signal process circuit for a transmission signal, based on an embodiment of the present disclosure.

Referring to FIG. 20, a signal processing circuit 1000 may include scramblers 1010, modulators 1020, a layer mapper 1030, a precoder 1040, resource mappers 1050, and signal generators 1060. An operation/function of FIG. 20 may be performed, without being limited to, the processors 102 and 202 and/or the transceivers 106 and 206 of FIG. 19. Hardware elements of FIG. 20 may be implemented by the processors 102 and 202 and/or the transceivers 106 and 206 of FIG. 19. For example, blocks 1010 to 1060 may be implemented by the processors 102 and 202 of FIG. 19. Alternatively, the blocks 1010 to 1050 may be implemented by the processors 102 and 202 of FIG. 19 and the block 1060 may be implemented by the transceivers 106 and 206 of FIG. 19.

Codewords may be converted into radio signals via the signal processing circuit 1000 of FIG. 20. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 20. For example, the wireless devices (e.g., 100 and 200 of FIG. 19) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

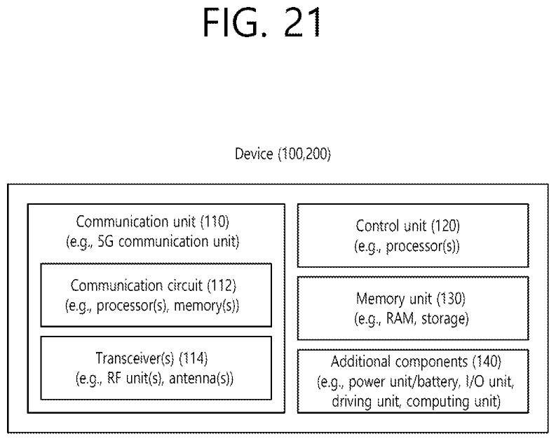

FIG. 21 shows another example of a wireless device, based on an embodiment of the present disclosure. The wireless device may be implemented in various forms according to a use-case/service (refer to FIG. 18).

Referring to FIG. 21, wireless devices 100 and 200 may correspond to the wireless devices 100 and 200 of FIG. 19 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 19. For example, the transceiver(s) 114 may include the one or more transceivers 106 and 206 and/or the one or more antennas 108 and 208 of FIG. 19. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 18), the vehicles (100b-1 and 100b-2 of FIG. 18), the XR device (100c of FIG. 18), the hand-held device (100d of FIG. 18), the home appliance (100e of FIG. 18), the IoT device (100f of FIG. 18), a digital broadcast terminal, a hologram device, a public safety device, an MTC device, a medicine device, a fintech device (or a finance device), a security device, a climate/environment device, the AI server/device (400 of FIG. 18), the BSs (200 of FIG. 18), a network node, etc. The wireless device may be used in a mobile or fixed place according to a use-example/service.

In FIG. 21, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof

Hereinafter, an example of implementing FIG. 21 will be described in detail with reference to the drawings.

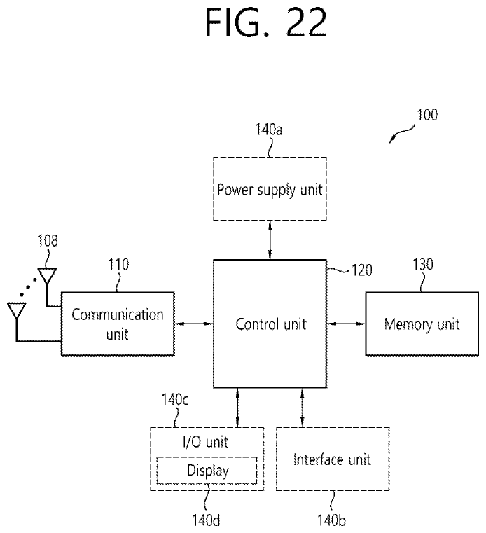

FIG. 22 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 22, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 21, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

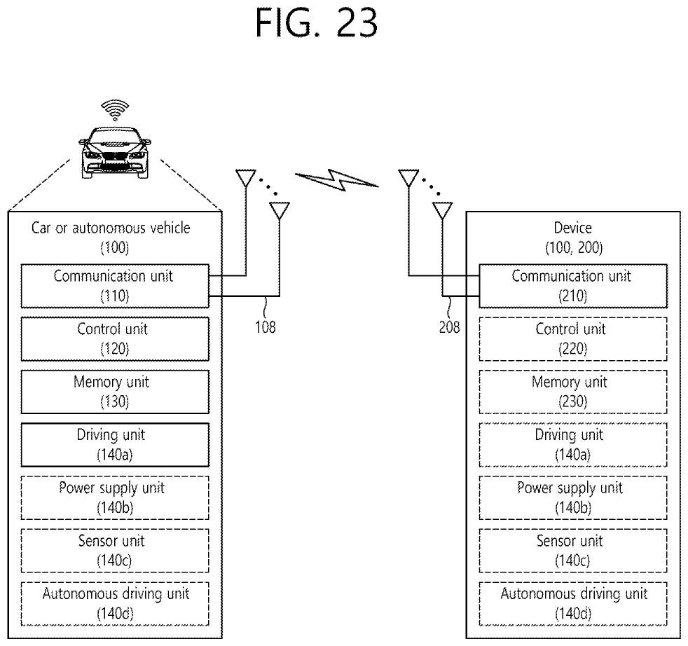

FIG. 23 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc.

Referring to FIG. 23, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 21, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing wireless communication by a first device, the method comprising:
selecting a sidelink (SL) discontinuous reception (DRX) configuration for groupcast communication from among at least one SL DRX configuration, wherein the SL DRX configuration includes information related to a DRX cycle and information related to an active time;
transmitting, to at least one second device within a group, first sidelink control information (SCI) for scheduling a physical sidelink shared channel (PSSCH) through a physical sidelink control channel (PSCCH);
transmitting, to the at least one second device, second SCI including information related to the SL DRX configuration and a destination ID through the PSSCH; and
performing, based on the SL DRX configuration, the groupcast communication with the at least one second device.

2. The method of claim 1, wherein the SL DRX configuration is selected based on an ID of the group from among the at least one SL DRX configuration.

3. The method of claim 1, wherein the SL DRX configuration is selected based on an ID of a zone to which the group belongs from among the at least one SL DRX configuration.

4. The method of claim 1, wherein the SL DRX configuration is selected based on a size of the group from among the at least one SL DRX configuration.

5. The method of claim 4, wherein, as the size of the group increases, the active time is configured as a larger value.

6. The method of claim 1, wherein a size of the group is determined based on the SL DRX configuration.

7. The method of claim 6, wherein a number of devices within the group is not allowed to exceed the size of the group related to the SL DRX configuration.

8. The method of claim 1, wherein the active time is divided into N sub-active times, and
wherein N is a positive integer.

9. The method of claim 8, wherein a device within the group is allowed to use at least one sub-active time among the N sub-active times based on an ID of the device.

10. The method of claim 8, wherein a device within the group is allowed to use at least one sub-active time among the N sub-active times based on an ID of the device and an ID of a zone to which the device belongs.

11. The method of claim 10, wherein the ID of the device is at least one of a member ID of the device, a source ID of the device, or a destination ID of the device.

12. The method of claim 1, wherein the information related to the SL DRX configuration is an index representing the SL DRX configuration among the at least one SL DRX configuration.

13. The method of claim 1, wherein the second SCI including the information related to the SL DRX configuration and the destination ID is transmitted based on a DRX resource pool,
wherein the DRX resource pool is a common resource pool used by devices performing DRX operations, and
wherein the SL DRX configuration is a common SL DRX configuration used by devices within the group.

14-20. (canceled)

21. A first device adapted to perform wireless communication, the first device comprising:
at least one transceiver;
at least one processor; and
at least one memory connected to the at least one processor and storing instructions that, based on being executed by the at least one processor, perform operations comprising:
selecting a sidelink (SL) discontinuous reception (DRX) configuration for groupcast communication from among at least one SL DRX configuration, wherein the SL DRX configuration includes information related to a DRX cycle and information related to an active time;
transmitting, to at least one second device within a group, first sidelink control information (SCI) for scheduling a physical sidelink shared channel (PSSCH) through a physical sidelink control channel (PSCCH);
transmitting, to the at least one second device, second SCI including information related to the SL DRX configuration and a destination ID through the PSSCH; and
performing, based on the SL DRX configuration, the groupcast communication with the at least one second device.

22. The first device of claim 21, wherein the SL DRX configuration is selected based on an ID of the group from among the at least one SL DRX configuration.

23. The first device of claim 21, wherein the SL DRX configuration is selected based on an ID of a zone to which the group belongs from among the at least one SL DRX configuration.

24. The first device of claim 21, wherein the SL DRX configuration is selected based on a size of the group from among the at least one SL DRX configuration.

25. A processing device adapted to control a first device, the processing device comprising:
at least one processor; and
at least one memory connected to the at least one processor and storing instructions that, based on being executed by the at least one processor, perform operations comprising:
selecting a sidelink (SL) discontinuous reception (DRX) configuration for groupcast communication from among at least one SL DRX configuration, wherein the SL DRX configuration includes information related to a DRX cycle and information related to an active time;
transmitting, to at least one second device within a group, first sidelink control information (SCI) for scheduling a physical sidelink shared channel (PSSCH) through a physical sidelink control channel (PSCCH);
transmitting, to the at least one second device, second SCI including information related to the SL DRX configuration and a destination ID through the PSSCH; and
performing, based on the SL DRX configuration, the groupcast communication with the at least one second device.

26. The processing device of claim 25, wherein the SL DRX configuration is selected based on an ID of the group from among the at least one SL DRX configuration.

27. The processing device of claim 25, wherein the SL DRX configuration is selected based on an ID of a zone to which the group belongs from among the at least one SL DRX configuration.
